(19) United States
(12) Patent Application Publication
(10) Pub. No.: US 2020/0207027 A1
(43) Pub. Date: Jul. 2, 2020

(54) JOINING STRUCTURE AND METHOD OF MANUFACTURING JOINING STRUCTURE

(71) Applicants: MAHLE International GmbH, Stuttgart (DE); MAHLE Filter Systems Japan Corporation, Tokyo (JP)

(72) Inventors: Yuichi Kato, Tokyo (JP); Yuta Ono, Tokyo (JP)

(21) Appl. No.: 16/729,388

(22) Filed: Dec. 28, 2019

(30) Foreign Application Priority Data
Dec. 28, 2018 (JP) 2018-246677

(51) Int. Cl. B29C 65/70; B29C 65/00

(52) U.S. Cl. CPC B29C 65/70; B29C 66/721; B29C 66/74283

(57) ABSTRACT

A lightweight joining includes a first member that has a first surface and a second surface 1b arranged on the back side of the first surface 1a, and a second member made of a resin material, the first member having a first hole that extends through the first member between the first surface and the second surface, the second member covering a region including the first hole on the first surface of the first member, a region including the first hole on the second surface of the first member, and an inner wall of the first member formed by the first hole, the second member being thus joined to the first member, and the second member having a second hole a diameter of which is smaller than that of the first hole such that the second hole fits into the first hole.

### CROSS REFERENCE TO RELATED APPLICATIONS

This application claims priority to Japanese patent application JP 2018-246677, filed Dec. 28, 2018, the entire content of which is incorporated herein by reference.

### TECHNICAL FIELD

The present disclosure relates to a joining structure and a method of manufacturing a joining structure, and in particular to a joining structure of a metal member and a resin member, and a method of manufacturing this joining structure, for example, a joining component in which thermoplastic resin is integrally molded on a metal member by an injection molding technique.

### BACKGROUND

In recent years, there has been a need for weight reduction of the resin members with which automobiles are configured. For example, connection components which are formed through integrated molding by overmolding a thermoplastic resin impregnated with fibers to a structure made of metal withstanding large composite inputs using an injection molding technique are increasing (see, e.g., JP 2013-256962).

FIGS. 8A and 8B are diagrams that illustrate an example of a connection component a metal member of which is integrally injection molded with a resin (thermoplastic resin). A perspective view of a connection component the metal member of which is integrally injection molded with a resin (thermoplastic resin) is shown in FIG. 8A and a cross-sectional view of this connection component is shown in FIG. 8B.

In general, the portion of contact of the metal member 901 and the resin member 902 in a connection component 900 as shown in FIGS. 8A and 8B does not exhibit retention performance and detachment and deformation may easily occur between the resin member 902 and the metal member 901.

For example, in FIG. 8B a case is shown in which torsional, tensile, and shear stresses (load) act upon the metal member 901 from the to-be-fastened component 903 side in a state where the metal member 901 side is fixed to the to-be-fastened component 903 such as an engine by fastening components such as a bolt 904 and a nut 905. In this case, as shown in FIG. 9, deformation may occur in the contact portion 910 of the resin member 902 and the metal member 901, which may lead to occurrence of detachment or deformation between the resin member 902 and the metal member 901.

For this reason, in such components, it is often the case that the portion of contact between the metal and the resin is fixed using fastening components such as bolts, nuts, collars, and subsequently mounted rivets as well as adhesives, etc. However, in a case where the above-described fastening components and the like are used, since the number of the components and processing processes increases, thus increasing the manufacturing in addition to the weight of the components, sufficient effects of the weight reduction have not been achievable by using the resin material.

In view of the above, prior to the present application a hole was formed in advance in a metal member and overmolded with a thermoplastic resin impregnated with fibers using an injection molding technique.

FIG. 10 is a cross-sectional view that illustrates a connection component the metal member of which is integrally injection molded with a resin (thermoplastic resin). The connection component 900A according to a preliminary study example depicted in the same figure differs from the connection component 900 illustrated in FIGS. 8A and 8B in that the hole 906 is formed in the metal member 901A prior to performing the injection molding and substantially identical with the connection component 900 in the remaining features. FIG. 10 depicts a perspective view of the connection component 900A which is viewed in the similar direction as in FIG. 8B.

As shown in FIG. 10, according to the manufacturing method, since an anchoring structure is formed by the resin member 902A that flowed into the hole 906 formed in the metal member 901A, it is made possible to increase the intensity of the connection between the metal member 901A and the resin member 902A.

However, according to this method, as illustrated in FIG. 11, when the resin member 902A is made to flow into the resin molding die 800 in a state where the metal member 901A is sandwiched in the resin molding die 800, a large amount of the resin member 902A flows into the hole 906 of the metal member 901A. As a result, a thick section 920 with raised resin member 902A may be formed in the hole 906 of the metal member 901A and the region around the hole 906. In this case, in order to impart strong retention performance to the joining portion between the resin and the metal, it will be necessary to perform additional and/or subsequent processing using different material joining technology such as chemical treatment, physical treatment by laser or the like, or any other similar treatment on the thick section 920, which will lead to increase in the manufacturing cost.

Also, as illustrated in FIG. 11, voids 930 which are a vacuum cavity and sinks 940 such as depression or deformation of the surface section of the resin side due to the difference in the linear expansion coefficients between the different materials are likely to occur in the above-described thick section 920. In a case where voids 930 have occurred, as illustrated in FIG. 12, when the resin member 902A is cooled, breakage of the resin member 902A may occur at the voids 930. Also, in a case where sinks 940 have occurred, as illustrated in FIG. 13, when the resin member 902A is cooled, waving of the resin member 902A may occur at the sinks 940 and breakage of the resin member 902A may occur. In this manner, in a case where the thick section 920 is created, the quality of the resin member 902A may be degraded.

As discussed above, it is not easy to ensure, in a joining structure joining different materials, level of performance (level of quality) as well as weight reduction of the component while reducing the cost.

### SUMMARY

It is an object of the present disclosure to achieve higher performance and weight reduction in a joining structure joining different materials while reducing the cost.

In accordance with an aspect of the present disclosure, a joining structure includes a first member having a first surface and a second surface arranged on the back side of the first surface, and a second member made of a resin material, the first member having a first hole that is formed so as to extend through the first member between the first surface and the second surface, the second member covering a region including the first hole on the first surface of the first member, a region including the first hole on the second surface of the first member, and an inner wall of the first member formed by the first hole, the second member being thus joined to the first member, the second member having a second hole having a diameter smaller than that of the first hole, and the second hole being formed such that the second hole fits into the first hole.

According to an aspect of the disclosure, the region in the resin member as the first member closing the first hole of for example a metal member as the second member is not thicker than the other regions, and has a smaller number of voids and sinks, so that creation of cracks, deformations, etc. does not easily occur in the resin member. By virtue of this, it is made possible to achieve a joining structure of a metal member and a resin member having high performance such as strength, durability, and stiffness.

Also, according to an aspect of the disclosure, fastening components such as bolts and nuts, etc. do not need to be provided to join the metal member and the resin member, it can fully demonstrate the light weight property by using resin, and weight reduction for the joining component as a whole is made possible. Also, according to this aspect, since the joining structure of the second member and the first member can be formed in a step of an injection molding process of resin without performing work for fastening bolts and nuts, etc. as well as additional processing and subsequent processing by different material joining technology, it is made possible to suppress an increase in the manufacturing cost.

In the above-described joining structure, the resin material may be a composite material containing fibers.

According to an aspect of the disclosure, it is made possible to achieve further reduction in the weight of the resin member.

In the above-described joining structure, the first member may be made of a metal material.

According to an aspect of the disclosure, a strong joining structure between the metal member and the resin member can be achieved.

In the above-described joining structure, the second hole may be formed coaxially with the first hole.

According to an aspect of the disclosure, since the thickness of the resin formed inside the first hole is uniform, it is made possible to further prevent creation of voids and sinks and to further suppress degradation in quality.

In the above-described joining structure, the second hole may be a through hole.

In the above-described joining structure, the second hole may be a non-through hole.

According to an aspect of the disclosure, it is made possible to achieve a structure that prevents fluids such as water from entering the inside of the resin member.

In the above-described joining structure, a plurality of the first holes are formed in the first member and a plurality of the second holes are correspondingly formed at regions in the second member corresponding to the first holes.

According to an aspect of the disclosure, since the metal member and the resin member are joined via the multiple first holes and the multiple second holes, it is made possible to further improve the joining strength.

Also, in accordance with another aspect of the present disclosure, a method of manufacturing a joining structure includes a first member and a second member made of a resin material, wherein the first and second members are joined to each other and the first member has a first hole extending through the first member. The method includes a first step of placing the first member in a die for injection molding having a protruding part whose diameter is smaller than that of the first hole, wherein the first member is placed in the die such that the protruding part fits into the first hole, a second step of filling the die with a melted thermoplastic resin material in a state where the first member is sandwiched in the die, and a third step of taking out, from the die, the first member formed in one piece with the second member with the thermoplastic resin material having cured.

According to an aspect of the disclosure, the resin member as the second member covers the region of the metal member as the first member including the first hole in the first surface, the region of the metal member including the first hole in the second surface, and the inner wall of the metal member formed by the first hole and this the second member is joined to the metal member. In addition, the resin member has the second hole the diameter of which is smaller than that of the first hole, where the second hole is formed such that the second hole fits into the first hole. By virtue of this, it is made possible to achieve the above-described high-performance and light weight joining structure of a metal member and a resin member at low cost.

In the above-described method of manufacturing the joining structure, the resin material may be a composite material containing fibers. By virtue of this, it is made possible to achieve further reduction in the weight of the resin member.

In the above-described method of manufacturing the joining structure, the first member may be made of a metal material.

In the above-described manufacturing method, the protruding part may be formed such that the protruding part becomes coaxial with the first hole when the first member is placed in the die.

According to an aspect of the disclosure, since the thermoplastic resin material flows evenly around the protruding part of the first hole, the thickness of the resin covering the inner wall of the first hole becomes uniform. By virtue of this, it is made possible to further prevent creation of voids and sinks in the resin member and suppress degradation of quality.

In the above-described manufacturing method, the protruding part may be shaped such that a through hole is formed in a region of the second member corresponding to the first hole when the second member is formed.

In the above-described manufacturing method, the protruding part may be shaped such that a non-through hole is formed in a region of the second member corresponding to the first hole when the second member is formed.

In the above-described manufacturing method, it is characterized by the fact that the die includes a core and a cavity, and the protruding part is formed in the cavity.

According to this aspect, positioning of the protruding part relative to the first hole is facilitated when the metal member is fixed to the cavity.

### Advantageous Effects of Invention

According to the present disclosure, it is made possible to achieve high performance and light weight of a joining structure joining different materials while reducing the cost.

### BRIEF DESCRIPTION OF THE DRAWINGS

The disclosure will now be described with reference to the drawings wherein:

FIG. 1A is a perspective view illustrating a joining component having a joining structure joining different materials according to a first exemplary embodiment;

FIG. 1B is a cross-sectional view illustrating the joining component having the joining structure joining different materials according to the first exemplary embodiment;

FIG. 2A is a plan view illustrating the joining structure near a hole of the metal member in the joining component according to the first exemplary embodiment;

FIG. 2B is a cross-sectional view illustrating the joining structure near the hole of the metal member in the joining component according to the first exemplary embodiment;

FIG. 3 is a diagram that schematically illustrates the state where a load (stress) acts upon the joining portion of the resin member and the metal member in the joining component according to the first exemplary embodiment;

FIG. 4A is a perspective view illustrating a joining component having a joining structure joining different materials according to a second exemplary embodiment;

FIG. 4B is a cross-sectional view illustrating the joining component having the joining structure joining different materials according to the second exemplary embodiment;

FIG. 5A is a perspective view illustrating a joining component having a joining structure joining different materials according to a third exemplary embodiment;

FIG. 5B is a cross-sectional view illustrating the joining component having the joining structure joining different materials according to the third exemplary embodiment;

FIG. 6A is a diagram for explanation of the individual steps in a method of manufacturing a joining component according to a fourth exemplary embodiment;

FIG. 6B is a diagram for explanation of the individual steps in the method of manufacturing a joining component according to the fourth exemplary embodiment;

FIG. 6C is a diagram for explanation of the individual steps in the method of manufacturing a joining component according to the fourth exemplary embodiment;

FIG. 6D is a diagram for explanation of the individual steps in the method of manufacturing a joining component according to the fourth exemplary embodiment;

FIG. 6E is a diagram for explanation of the individual steps in the method of manufacturing a joining component according to the fourth exemplary embodiment;

FIG. 6F is a diagram for explanation of the individual steps in the method of manufacturing a joining component according to the fourth exemplary embodiment;

FIG. 7 is a diagram that schematically illustrates the state of the inside of the die into which the resin has flowed;

FIG. 8A is a perspective view illustrating an example of a conventional connection component a metal member of which is integrally injection molded with a resin (thermoplastic resin);

FIG. 8B is a cross-sectional view illustrating an example of a conventional connection component the metal member of which is integrally injection molded with a resin (thermoplastic resin);

FIG. 9 is a diagram that schematically illustrates the state where a load (stress) acts upon the joining portion of the resin member and the metal member in the connection component illustrated in FIG. 8A;

FIG. 10 is a cross-sectional view illustrating a connection component the metal member of which is integrally injection molded with a resin (thermoplastic resin), which the inventors of the present application scrutinized prior to the present application;

FIG. 11 is a diagram that schematically illustrates the state of the inside of the die into which the resin flows in the manufacturing process of the connection component according to a preliminary study;

FIG. 12 is a diagram that schematically illustrates breakage of the resin member due to voids when a load (stress) acts upon the joining portion of the resin member and the metal member of the connection component according to the preliminary study example; and

FIG. 13 is a diagram that schematically illustrates breakage of the resin member due to sinks when a load (stress) acts upon the joining portion of the resin member and the metal member of the connection component according to the preliminary study.

### DESCRIPTION OF EXEMPLARY EMBODIMENTS

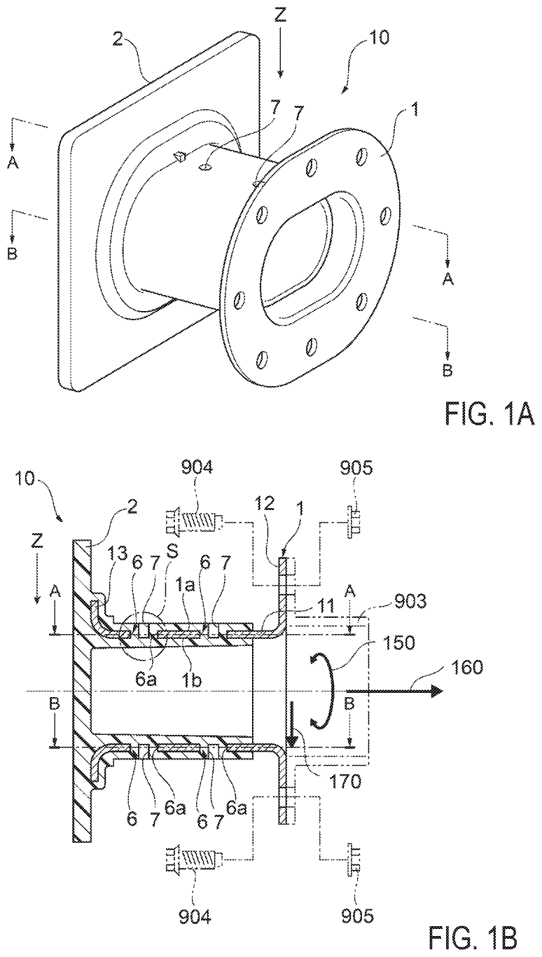

FIGS. 1A and 1B are diagrams that illustrate a joining component having a joining structure joining different materials according to the first exemplary embodiment. FIG. 1A depicts a perspective view of a joining component having a joining structure joining different materials, and FIG. 1B depicts a cross-sectional view of the joining component having the joining structure illustrated in FIG. 1A.

The joining component 10 illustrated in FIGS. 1A and 1B has a joining structure in which a first member 1 and a second member 2 made of a resin material are joined.

A resin material of which the second member 2 is made is a material having resin as its main component and, for example, is a composite material in which thermoplastic resin is impregnated with fibers. Examples of the thermoplastic resin are polyamide, polypropylene, polycarbonate, etc. Examples of the fibers are glass fibers, carbon fibers, etc.

The second member 2 can be formed, for example, by an injection molding technique (overmolding method) which forms one material on another material. Specifically, the second member 2 can be formed by overmolding the aforementioned thermoplastic resin upon the first member 1. Hereinafter, the second member 2 may also be referred to as “resin member 2.”

The material of which the first member 1 is made is a material different than the aforementioned resin material and is, for example, a metal material such as stainless steel. Hereinafter, the first member 1 may also be referred to as “metal member 1.” The metal member 1 is formed, for example, by press molding or forging and casting techniques.

As illustrated in FIG. 1B, the metal member 1 has a surface 1a as a first surface and a back surface 1b as a second surface arranged on the back side of the surface 1a. Specifically, the metal member 1 has, for example, as illustrated in FIG. 1B, a cylindrical section 11 formed in a cylindrical shape and flange sections 12 and 13 at both end portions of the cylindrical section 11. The cylindrical section 11 is, for example, a pipe whose cross section is circular (for example, rounded rectangle or an ellipse). The flange section 12 has a disc shape formed at one end portion of the cylindrical section 11 so as to protrude in the direction perpendicular to the central axis of the cylindrical section 11 (i.e., the radial direction of the cylindrical section 11). For example, the flange section 12 is a functional section for fixing the metal member 1 to a to-be-fastened component 903 such as an engine by fastening components such as a bolt 904 and a nut 905.

The flange section 13 has a disc shape formed at the other end portion of the cylindrical section 11 so as to protrude in the direction perpendicular to the central axis of the cylindrical section 11 (i.e., the radial direction of the cylindrical section 11). For example, the flange section 13 functions as a locking part for ensuring that the overmolded resin member 2 does not get out of the cylindrical section 11.

In the metal member 1, a first hole 6 (which hereinafter may also be simply referred to as “hole 6”) is formed which extends through the metal member 1 between the surface 1 a and the back surface 1b. Specifically, the hole 6 is a through hole which extends through, for example, the outer peripheral surface and the inner peripheral surface of the cylindrical section 11. The hole 6 is formed, for example, in a circular shape (for example, a circle, a rounded rectangle, or an ellipse). A plurality of the holes 6 are formed in a region in the metal member 1 in contact with the resin member 2. In FIGS. 1A and 1B, as one example, a case is illustrated where four holes 6 are formed in the cylindrical section 11 of the metal member 1.

Note that at least one hole 6 should be formed in the region in the metal member 1 in contact with the resin member 2 and the number thereof is not in particular limited. Also, the diameter of the hole 6 is for example within the range of 8 to 10 mm.

Thereafter, the joining structure of the resin member 2 and the metal member 1 in the joining component 10 will be described.

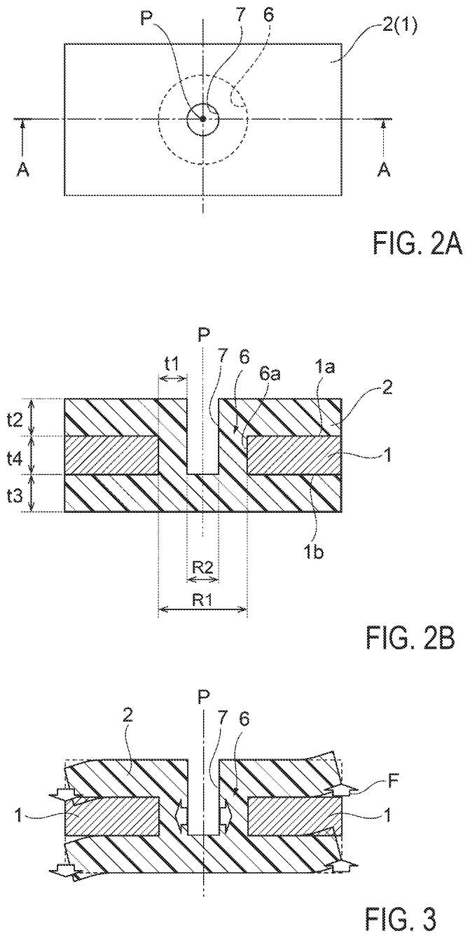

FIGS. 2A and 2B are diagrams that illustrate the joining structure at and near the hole 6 of the metal member 1 of the joining component 10 according to the first exemplary embodiment. FIG. 2A depicts a plan view of a certain region S in the joining portion of the resin member 2 and the metal member 1 illustrated in FIGS. 1A and 1B when viewed in the Z-direction of FIG. 1B, and FIG. 2B depicts a cross-sectional view which illustrates the A-A cross section of the region S illustrated in FIG. 2A.

As illustrated in FIGS. 2A and 2B, the resin member 2 covers the region including the hole 6 in the surface la of the metal member 1, the region including the hole 6 in the back surface 1b of the metal member 1, and the inner wall 6a of the metal member 1, which is formed by the hole 6, and is joined to the metal member 1.

As illustrated in FIGS. 2A and 2B, in the resin member 2, a second hole 7 (which hereinafter may also be simply referred to as “hole 7”) the diameter of which is smaller than that of the hole 6 of the metal member 1 is formed such that it fits into the hole 6.

The hole 7 is formed, for example, coaxially with the central axis P of the hole 6. The hole 7 is formed, for example, in a circular shape (for example, a circle, a rounded rectangle, or an ellipse). Also, the hole 7 is formed, for example, concentrically with the hole 6. When the diameter of the hole 6 is R1 and the diameter of the hole 7 is R2, then R1>R2. Also, as illustrated in FIG. 2B, the hole 7 is a non-through hole that does not penetrate the resin member 2 at the hole 6 in the metal member 1. Note that the depth of the hole 7 is not in particular limited.

Here, it is typical that the thickness of the resin (thermoplastic resin material) formed in and around the inside of the hole 6 of the metal member 1 is uniform. For example, when the thickness of the resin (thermoplastic resin material) covering the inner wall 6a of the hole 6 of the metal member 1 is t1, the thickness of the resin covering the surface 2a side of the metal member 1 is t2, and the thickness of the resin covering the back surface 1b side on the back side of the surface 1a of the metal member 1 is t3, then it is typical that “t1≈t2∓t3.”

FIG. 3 is a diagram that schematically illustrates a state where the load (stress) acts upon the joining portion of the resin member 2 and the metal member 1 in the joining component 10 according to the first exemplary embodiment. The same figure depicts, in a manner similar to FIG. 2B, a cross-sectional shape of a certain region S in the joining portion of the resin member 2 and the metal member 1.

For example, as illustrated in FIG. 1B, in a state where the metal member 1 side is fixed to a to-be-fastened component 903 such as an engine by the fastening components such as the bolt 904 and the nut 905, in a case where torsional, shear, and tensile stress (load) F acts upon the joining portion of the metal member 1 and the resin member 2 from the to-be-fastened component 903 side, as illustrated in FIG. 3, it is made possible to suppress deformation of the resin member 2 in the aforementioned joining portion.

In other words, when the metal member 1 is overmolded with the thermoplastic resin using an injection molding technique, as a result of the melted thermoplastic resin flowing into the hole 6 formed in the metal member 1, the region including the hole 6 of the surface 1a of the metal member 1, the region including the hole 6 of the back surface 1b of the metal member 1, and the inner wall 6a of the metal member 1 formed by the hole 6 are each covered by the resin member 2. By virtue of this, since an anchoring structure is formed in which the surface 1a side of the metal member 1 and the back surface 1b side of the metal member 1 are coupled by resin via the hole 6, it is made possible to further enhance strength, durability, and stiffness of the joining portion of the metal member 1 and the resin member 2 as compared with conventional ones.

Also, in the joining structure of the resin member 2 and the metal member 1 according to the first exemplary embodiment, the hole 7 the diameter of which is smaller than that of the hole 6 of the metal member 1 is formed in the resin member 2 such that it fits into the hole 6. By virtue of this, in the resin member 2, the region closing the hole 6 of the metal member 1 does not have a thickness larger than the other regions, and a smaller number of voids and sinks are present, so that cracks, deformation, etc. of the resin member 2 are less likely to occur. By virtue of this, it is made possible to achieve the joining structure of the metal member 1 and the resin member 2 having high performance such as strength, durability and stiffness.

Also, according to the joining structure, since the joining structure of the resin member 2 and the metal member 1 can be formed in the step of the injection molding process of resin, additional and/or subsequent processing using different material joining technology such as chemical treatment, physical treatment by laser or the like, or any other similar treatment does not need to be performed, which makes it possible to suppress increase in the manufacturing cost.

Also, according to this joining structure, since fastening components such as bolts and nuts do not need to be provided in order to join the metal member 1 and the resin member 2, it is made possible to suppress increase in the manufacturing cost due to increase in the number of components, in addition to which it can fully demonstrate the light weight property by using resin, and weight reduction for the joining component as a whole can be achieved. In particular, in a case where the resin member 2 is formed by a composite material (thermoplastic resin) impregnated with fibers such as glass fiber, carbon fiber, etc., it is made possible to achieve further weight reduction of the joining component as a whole.

Also, in this joining structure, by forming the hole 7 of the resin member 2 coaxially with the hole 6 of the metal member 1, the thickness of the resin formed in the inside of the hole 6 of the metal member 1 becomes uniform and the number of the voids and sinks can be further reduced, which makes it possible to achieve a joining structure having higher quality.

Further, as has been discussed in the foregoing, by making the thickness of the resin around the hole 6 to be “t1≈t2≈t3,” the stress acting around the hole 6 of the resin member 2 can be made uniform, so that it is made possible to further enhance the strength of the joining.

Also, in this joining structure, by forming a plurality of the holes 6 in the metal member 1 and correspondingly forming the holes 7 at the regions of the resin member 2 corresponding to the hole 6, the metal member 1 and the resin member 2 are joined via the multiple holes 6 and the multiple holes 7, so that it is made possible to further enhance the joining strength.

Also, in this joining structure, since the hole 7 formed in the resin member 2 is a non-through hole that does not penetrate the resin member 2, for example, such a highly watertight structure that the fluid such as water does not enter the inside of the resin member 2 via the hole 7 can be achieved.

In the following, specific numerical examples are illustrated regarding the effects of the joining structure according to the first exemplary embodiment.

For example, if the diameter R1 of the hole 6 of the metal member 1 in FIG. 1A etc. is 12 mm and the diameter R2 of the hole 7 of the resin member 2 is 8 mm, and the thickness t1 (≈t2≈t3) of the resin (thermoplastic resin material) covering the inner wall 6a of the hole 6 of the metal member 1 is 4.0 mm, then, the load bearing capacity of the resin member 2 against the composite input (torsional stress, shear stress, and tensile stress) to the joining component 10 was able to be increased by about +5% per one hole 6 and 7 (which is about +10% per one hole 6 and 7 if only the tensile stress is input), according to CAE (computer aided engineering) performance analysis, as compared with a case where the holes 6 and 7 are not formed. Also, in a case where four holes 6 and 7 are formed, the aforementioned load bearing capacity can be increased by about +20%. Further, if the thickness t4 of the metal member 1 was 4.0 mm, then the weight reduction by about −25 g per one hole 6 and 7 can be achieved.

In this manner, according to the joining structure in accordance with the first exemplary embodiment, it is made possible to achieve higher performance and weight reduction of a joining structure joining different materials while reducing the cost.

### Second Embodiment

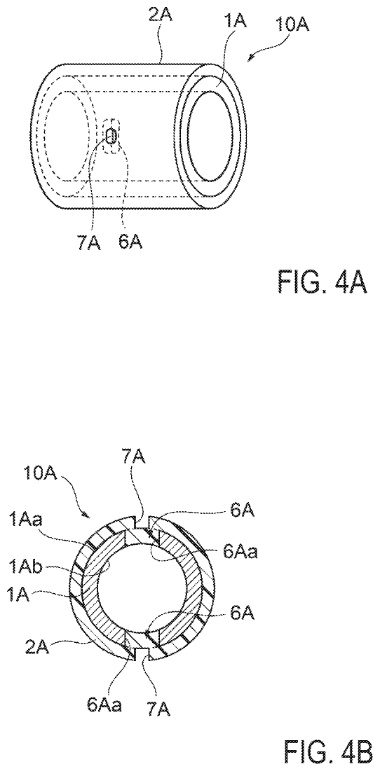

FIGS. 4A and 4B are diagrams that illustrate a joining component having a joining structure joining different materials according to the second exemplary embodiment. FIG. 4A depicts a perspective view of a joining component 10A having a joining structure according to the second exemplary embodiment, and FIG. 4B depicts a cross-sectional view of the joining component 10A illustrated in FIG. 4A.

The joining component 10A illustrated in FIGS. 4A and 4B has a joining structure in which the metal member 1A as the first member and the resin member 2A as the second member made of a resin material are joined.

The metal member 1A is a cylindrical component. For example, the metal member 1A is formed in a cylindrical shape. Note that the cross-sectional shape of the metal member 1A is not limited to a circular shape, and may be an elliptical, rounded rectangular, or rectangular shape. The metal member 1A is made of a metal material similar to that of the metal member 1 according to the first exemplary embodiment.

In the metal member 1A, a hole 6A that extends through the metal member 1A is formed. Specifically, the hole 6A is, for example, a through hole that extends through the outer peripheral surface and the inner peripheral surface of the cylindrical metal member 1A.

With regard to the hole 6A, at least one hole 6A is formed in a region in a metal member 1A in contact with the resin member 2A. In FIGS. 4A and 4B, a case is illustrated, as an example, where two holes 6A are formed in the metal member 1A.

The hole 6A is formed, for example, in a circular shape. In FIGS. 4A and 4B, a case is illustrated, as an example, where the hole 6A is in a rounded rectangular shape, but the shape of the hole 6A is not limited to this and various shapes may be adopted.

The resin member 2A is, in the manner similar to that of the resin member 2 according to the first exemplary embodiment, a material having resin as its main component and is made of, for example, a composite material (thermoplastic resin) impregnated with the fibers such as glass fiber, carbon fiber, etc. The resin member 2A is formed by overmolding the aforementioned thermoplastic resin upon the metal member 1A by an injection molding technique.

As illustrated in FIGS. 4A and 4B, the resin member 2A covers the region including the hole 6A in the surface 1Aa of the metal member 1A, the region including the hole 6A in the back surface 1Ab of the metal member 1A, and the inner wall 6Aa of the metal member 1A formed by the hole 6A, and is thus joined to the metal member 1A.

As illustrated in FIGS. 4A and 4B, in the region in the resin member 2A corresponding to the hole 6A formed in the metal member 1A, a hole 7A the diameter of which is smaller than that of the hole 6A is formed such that it fits into the hole 6A.

As illustrated in FIG. 4B, the hole 7A is a non-through hole that does not penetrate the resin member 2A at the hole 6A of the metal member 1A. The hole 7A is formed, for example, in a circular shape (for example, a circle, a rounded rectangle, or an ellipse). For example, the hole 7A is coaxial with the central axis of the hole 6A and is formed concentrically with the hole 6A. In FIGS. 4A and 4B, a case is illustrated, as an example, where the hole 7A is in a rounded rectangular shape, but the shape of the holes 7B_1 to 7B_3 is not limited to them and various shapes may be adopted.

According to the above-described joining structure of the resin member 2A and the metal member 1A in accordance with the second exemplary embodiment, in the manner similar to that of the joining structure according to the first exemplary embodiment, it is made possible to achieve higher performance and weight reduction of a joining structure joining different materials while reducing the manufacturing cost.

### Third Embodiment

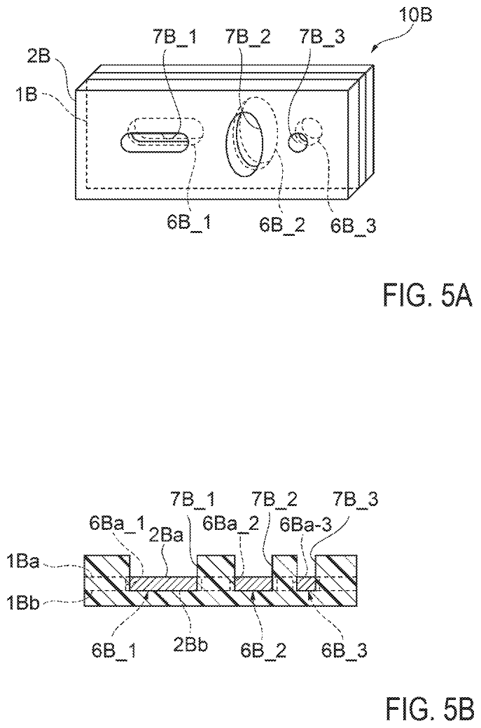

FIGS. 5A and 5B are diagrams that illustrate a joining component having a joining structure joining different materials according to a third exemplary embodiment. FIG. 5A depicts a perspective view of a joining component 10B that has the joining structure according to the third exemplary embodiment, and FIG. 5B depicts a cross-sectional view which illustrates the B-B cross-section of the joining component 10B illustrated in FIG. 5A.

The joining component 10B illustrated in FIGS. 5A and 5B has a joining structure in which a metal member 1B as the first member and a resin member 2B as the second member made of a resin material are joined.

The metal member 1B is a plate-like component. For example, the metal member 1A is formed in a rectangular shape in its plan view (for example, a shape of a rectangle). The metal member 1B is made of a metal material similar to that of the metal member 1 according to the first exemplary embodiment.

In the metal member 1B, holes 6B_1 to 6B_3 (which will be hereinafter simply referred to as “hole 6B” in a case where the individual holes 6B_1 to 6B_3 are not distinguished from each other) which extend through the metal member 1B are formed. Specifically, the hole 6B is, for example, a through hole that extend through the surface 1Ba of the plate-like metal member 1B and the back surface 1Bb arranged on the back side of the surface 1Ba.

With regard to the hole 6B, at least one hole 6B is formed in a region in the metal member 1B in contact with the resin member 2B. In FIGS. 5A and 5B, as an example, a case is illustrated in which three holes 6B_1 to 6B are formed in the metal member 1B.

The hole 6B is formed, for example, in a circular shape. In FIGS. 5A and 5B, a case is illustrated, as an example, where the hole 6B_1 is in a rounded rectangular shape, the hole 6B_2 is in an elliptical shape, and the hole 6B_3 is in a circular shape, but the shapes of the holes 6B_1 to 6B_3 are not limited to them and various shapes may be adopted.

The resin member 2B is, in the manner similar to that of the resin member 2 according to the first exemplary embodiment, made of a material having resin as its main component, for example, a composite material in which a thermoplastic resin is impregnated with fibers such as glass fiber, carbon fiber, etc. The resin member 2B is formed by overmolding the aforementioned thermoplastic resin upon the metal member 1B by an injection molding technique.

As illustrated in FIGS. 5A and 5B, the resin member 2B covers the region including the holes 6B_1 to 6B_3 in the surface 1Ba of the metal member 1B, the region including the holes 6B_1 to 6B_3 in the back surface 1Bb of the metal member 1B, and the inner walls 6Ba_1 to 6Ba_3 of the metal member 1B formed by the holes 6B_1 to 6B_3, and is thus joined to the metal member 1A.

As illustrated in FIGS. 5A and 5B, in the regions in the resin member 2B corresponding to the holes 6B_1 to 6B_3 of the metal member 1B, the holes 7B_1 to 7B_3 are correspondingly formed such that they get into corresponding holes 6B_1 to 6B_3. Here, the diameter of the holes 7B_1 to 7B_3 is smaller than that of the holes 6B_1 to 6B_3.

Note that, in the following description, in a case where the individual holes 7B_1 to 7B_3 are not distinguished from each other, they will be simply referred to as “hole 7B.”

As illustrated in FIG. 5B, the hole 7B is a non-through hole that does not penetrate the resin member 2B at the hole 6B of the metal member 1B. The hole 7B is, for example, in a circular shape (for example, a circle, a rounded rectangle, or an ellipse). For example, the hole 7B is coaxial with the central axis of the hole 6B and is formed concentrically with the hole 6B. In FIGS. 5A and 5B, a case is illustrated, as one example, where the hole 7B_1 is in a rounded rectangular shape, the hole 7B_2 is in an elliptical shape, and the hole 7B_3 is in a circular shape, but the shapes of the holes 7B_1 to 7B_3 are not limited to them and various shapes may be adopted.

According to the above-described joining structure of the resin member 2B and the metal member 1B according to the third exemplary embodiment, in the manner similar to that of the joining structure according to the first exemplary embodiment, it is made possible to achieve higher performance and weight reduction of a joining structure joining different materials while reducing the manufacturing cost.

### Fourth Embodiment

Thereafter, a method of manufacturing the joining structure joining different materials will be described.

Here, as one example, a method of manufacturing a joining component 10C joining a resin member 2C with the plate-like metal member 1C formed with a protruding central portion by overmolding with a thermoplastic resin by an injection molding technique will be described.

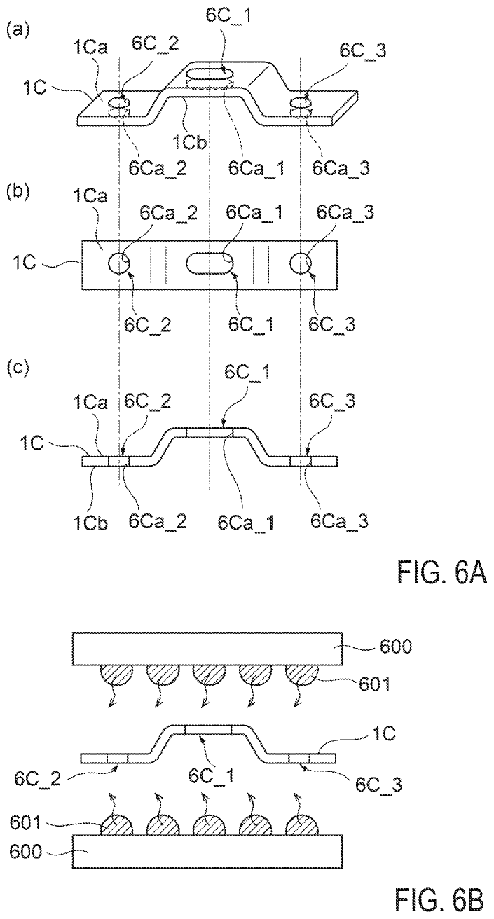

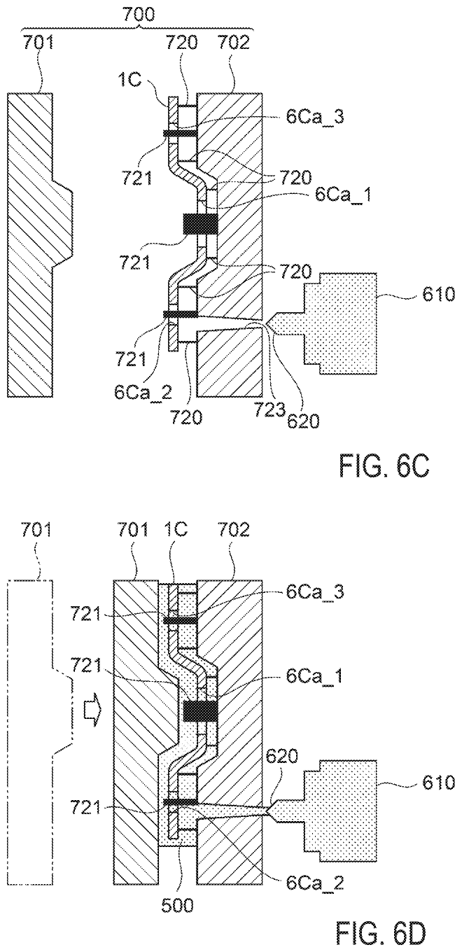

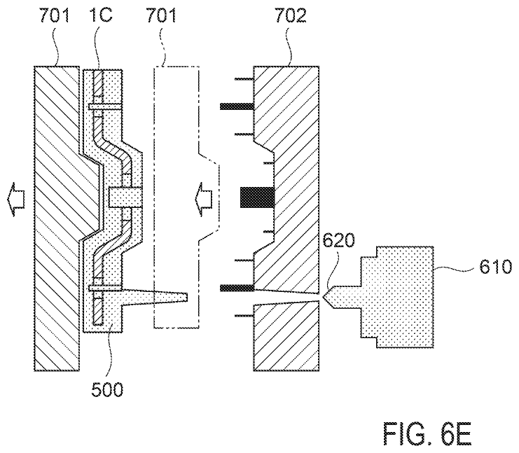

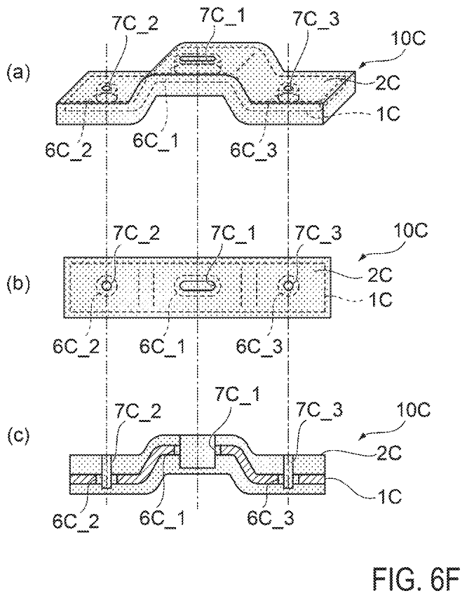

FIGS. 6A to 6F are diagrams for explanation of the individual steps in the method of manufacturing the joining component 10C according to the fourth exemplary embodiment.

First, a metal member 1C shaped in a predetermined shape is prepared (step S101).

For example, a metal member 1C as illustrated in FIG. 6A is prepared. In (a) of FIG. 6A, a perspective view of the metal member 1C is depicted; in (b) of FIG. 6A, a plan view of the metal member 1C is depicted; and in (c) of FIG. 6A, a cross-sectional view of the metal member 1C is depicted.

As illustrated in FIG. 6A, the metal member 1C is a plate-like component having a convex shape in its cross section which is formed with protruding central portion. For example, metal member 1C is made of a metal material similar to that of the metal member 1 according to the first exemplary embodiment.

In the metal member 1C, the holes 6C_1 to 6C_3 (which will be hereinafter simply referred to as “hole 6C” in a case where the individual holes 6C_1 to 6C_3 are not distinguished from each other) are formed. Specifically, the hole 6C is, for example, a through hole that extend through the surface 1Ca of the plate-like metal member 1C and the back surface 1Cb arranged on the back side of the surface 1Ca.

With regard to the hole 6C, at least one hole 6C is formed in a region in the metal member 1C in contact with the resin member 2C which will be described later. In FIG. 6A, as an example, a case is illustrated in which three the holes 6C_1 to 6C_3 are formed in the metal member 1C.

The hole 6C is formed, for example, in a circular shape. In FIG. 6A, a case is illustrated, as one example, where the hole 6C_1 is in a rounded rectangular shape and the holes 6C_2, 6C_3 are in a circular shape, but the shapes of the holes 6C_1 to 6C_3 are not limited to them and various shapes may be adopted.

Thereafter, the metal member 1C that has been prepared in the step S101 is heated (step S102). For example, as illustrated in FIG. 6B, the metal member 1C that has been prepared in the step S101 is heated by a heating device (heater) 600 that has a lighting tube 601.

Thereafter, the metal member 1C that has been heated in the step S102 is placed in the die 700 for use in injection molding (for use in resin molding) (step S103).

As illustrated in FIG. 6C, the die 700 includes a core 701 and a cavity 702. In the cavity 702, support pins 720 for supporting the metal member 1C in the die 700 are formed. Also, in the cavity 702, a protruding part 721 for forming a hole in the resin member for overmolding which will be described later is formed (which hereinafter may also be referred to as “hole forming pin 721”).

The hole forming pins 721 are provided for each of the holes 6C_1 to 6C_3 and, are formed so as to protrude such that they each get into the corresponding one of the holes 6C_1 to 6C_3 when the metal member 1C is placed in the die 700.

The individual hole forming pins 721 are formed, for example, in a columnar shape, the diameter of which is smaller than that of the corresponding holes 6C_1 to 6C_3.

Note that the hole forming pins 721 may be locked with not the cavity 702 but the core 701, or may be formed in the cavity 702 and the core 701, respectively.

Specifically, in the step S102, as illustrated in FIG. 6C, the metal member 1C is placed in the die (cavity 702) in which hole forming pins 721 are formed such that the individual hole forming pins 721 get into corresponding ones of the holes 6C_1 to 6C_3. More specifically, in a state where the hole forming pins 721 are inserted into the holes 6C_1 to 6C_3 of the metal member 1C, respectively, the metal member 1C is supported on the cavity 702 by the support pins 720.

Thereafter, the melted thermoplastic resin material 500 is made to flow into the die 700 in which the metal member 1C has been set in the step S102 (step S103). Specifically, as illustrated in FIG. 6D, in a state where the metal member 1C is sandwiched in the die 700, the inside of the die 700 is filled with the melted thermoplastic resin material 500 (which hereinafter may also be simply referred to as “resin 500”).

More specifically, the core 701 is moved to sandwich the metal member 1C by the core 701 and the cavity 702 and, after that, the melted resin 500 is introduced via the nozzle 620 of the injection molding machine 610 into the sprue 723 of the cavity 702. By virtue of this, the melted resin 500 flows into the gap between the core 701 and the cavity 702.

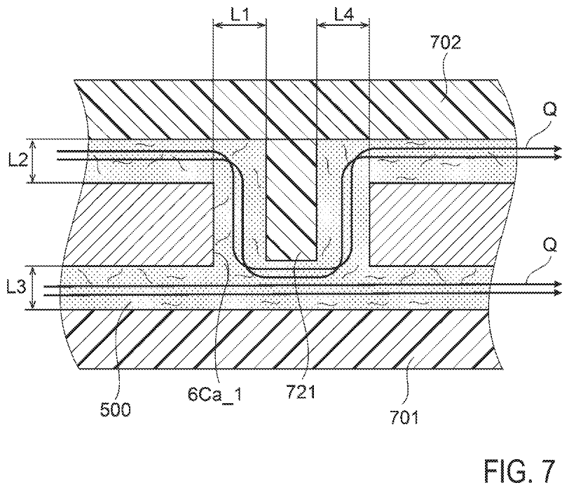

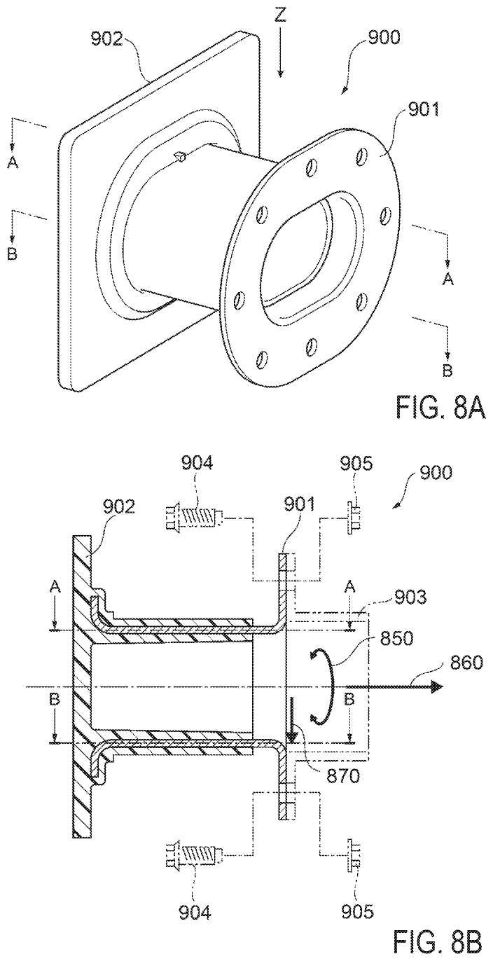

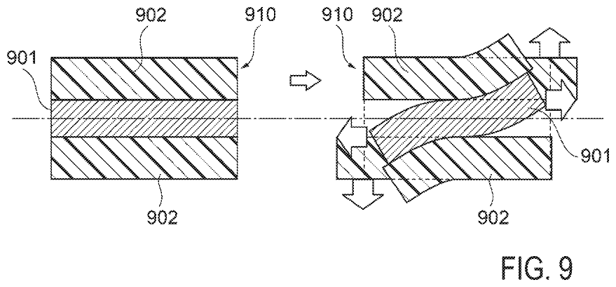

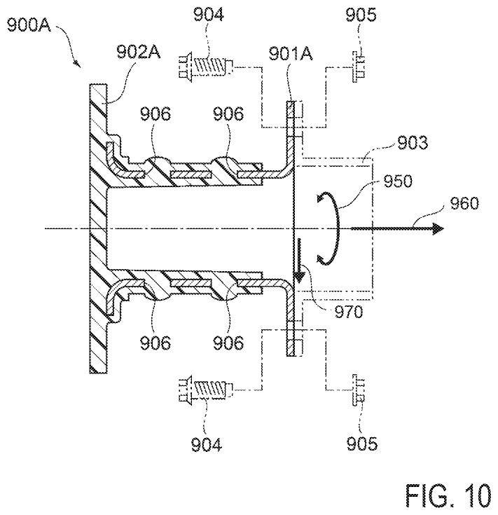

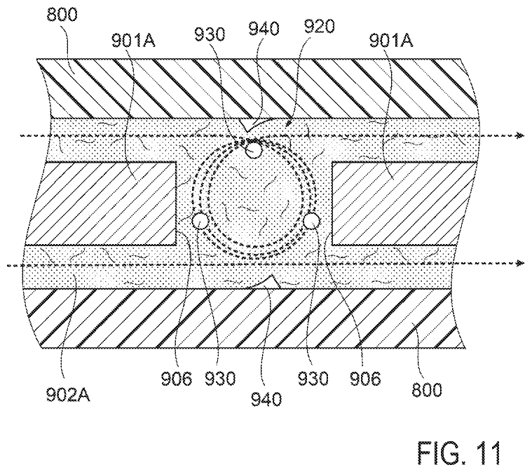

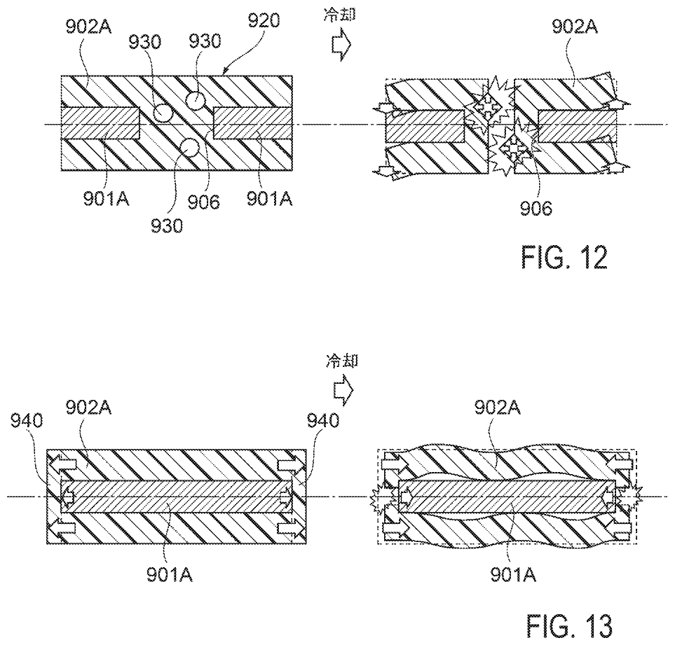

FIG. 7 is a diagram that schematically illustrates the state of the inside of the die into which the resin 500 has flowed.

The same figure depicts the state around the hole forming pin 721 inside the die 700 when the resin 500 is made to flow into it in the step S103.

As illustrated in FIG. 7, when the resin 500 is introduced into the die 700, as illustrated by the reference sign Q, the melted resin 500 flows inside the die 700 such that it reaches the other side of the hole forming pin 721. By virtue of this, it is made possible to create a region where the resin 500 does not exist in the inside of the hole 6C of the metal member 1C, and it is made possible to form the hole 7C in the region corresponding to the hole 6C of the resin member 2C which will be described later.

Here, it is typical that the hole forming pin 721 is formed to be coaxial with the hole 6C when the metal member 1C is placed in the die 700. By virtue of this, as illustrated in FIG. 7, the resin 500 flows uniformly into the portions around the hole forming pin 721 inserted into the hole 6C of the metal member 1C, which makes it possible to provide uniformity of the thickness of the resin formed in the inside of the hole 6C. By virtue of this, it is made possible to further prevent creation of voids and sinks in the resin member 2C.

When the distances between the inner wall 6Ca of the metal member 1C formed by the hole 6C and the hole forming pin 721 are L1 and L4, the distance between the surface 2Ca of the metal member 1C and the cavity 702 is L2, and the distance between the back surface 1Cb of the metal member 1C and the core 701 is L3, then it is typical that the hole forming pin 721 is formed to be L1≈L2≈L3≈L4. By virtue of this, it is made possible to provide uniformity of the thickness of the resin in the inside of the hole 6C and the thickness of the resin near the hole 6C. By virtue of this, since it is made possible to provide uniformity of the stress acting on the regions near the hole 6 of the resin member 1C, it is made possible to further enhance the strength of the joining.

Also, the hole forming pin 721 has such a shape that a non-through hole is formed in the region of the resin member 2C corresponding to the hole 6 when the resin member 2C as the second member, which will be described later, is formed. In other words, with regard to the hole forming pin 721, the tip of the hole forming pin 721 is not in contact with the core 701 when the metal member 1C is sandwiched in the die 700.

By virtue of this, it is made easier to make the hole 7c formed in the resin member 2C as a non-through hole.

Thereafter, the molded article that has been overmolded is taken out from the die 700 (step S104). Specifically, after the resin 500 has been made to flow into the die 700 in the step S103, the resin 500 that has been made to flow into the die 700 is cooled for a predetermined period of time under a predetermined pressure until it cures. After that, as illustrated in FIG. 6E, the core 701 is moved from the cavity 702 and the molded article in which the resin member 2C formed by the cured resin 500 and the metal member 1C are formed in one piece is taken out from the die 700. After that, the gate or the like of the molded article that has been taken out is treated as appropriate and thereby a joining component 10C can be obtained in which the resin member 2C is overmolded upon the metal member 1C as illustrated in FIG. 6F.

Note that (a) of FIG. 6F depicts a perspective view of the joining component 10C, (b) of FIG. 6F depicts a plan view of the joining component 10C, and (c) of FIG. 6F depicts a cross-sectional view of the joining component 10C.

As described, according to the method of manufacturing the joining structure joining different materials in accordance with the fourth exemplaryembodiment, the resin member 2C as the second member covers the region including the holes 6C_1 to 6C_3 in the surface 1Ca of the metal member 1C as the first member, the region including the holes 6C_1 to 6C_3 in the back surface 1Cb of the metal member 1C, and the inner walls 6Ca_1 to 6Ca_3 of the metal member 1C formed by the holes 6C_1 to 6C_3, and is thus joined to the metal member 1C.

By virtue of this, as has been discussed in the foregoing, an anchoring structure can be formed in which the surface 1Ca side of the metal member 1C and the back surface 1Cb side of the metal member 1C are joined by resin via the hole 6. By virtue of this, it is made possible to achieve a joining structure that further enhances the strength, durability, and stiffness of the joining portion of the metal member 1C and the resin member 2C as compared with conventional ones.

Also, in this manufacturing method, in the die 700, the hole forming pin 721 is formed as a protruding part which protrudes so as to get into the hole 6 when the metal member 1C is placed in the die 700 and has a diameter smaller than that of the hole 6.

By virtue of this, as has been discussed in the foregoing, since a region where the resin 500 does not exist (hole 7C) can be formed in the inside of the hole 6C of the metal member 1C, the thickness of the resin formed in the hole 6C of the metal member 1C can be prevented from being increased. By virtue of this, creation of voids and sinks in the resin formed in the hole 6C of the metal member 1C can be prevented and the above-described high-performance joining structure can be achieved.

Also, according to this manufacturing method, fastening components such as bolts and nuts, etc. do not need to be provided to join the metal member and the resin member, it can fully demonstrate the light weight property by using resin, and it is made possible to achieve weight reduction of the joining component 10C as a whole. In particular, by using, as the resin 500, a composite material (thermoplastic resin) impregnated with fibers such as glass fiber, carbon fiber, etc., it is made possible to achieve further weight reduction of the joining component 10C as a whole.

Also, according to this manufacturing method, without performing work for fastening bolts and nuts as well as additional processing and subsequent processing by different material joining technology, the joining structure of the metal member 1C and the resin member 2C can be formed in the step of the injection molding process of resin, so that it is made possible to suppress increase in the manufacturing cost.

In this manner, according to this manufacturing method, it is made possible to achieve high-performance and light weight, a joining structure of a metal member and a resin member at lower cost.

Also, according to this manufacturing method, through adjustment of the length of the hole forming pin 721, whether or not the hole 7c to be formed in the resin member 1C extends therethrough can be readily changed. By virtue of this, for example, in a case where there is a need on the user's side for ensuring that fluids such as water do not enter the inside of the resin member 2C via the hole 7C, changes to the machining work such as making the hole 7C as a non-through hole are facilitated.

Whilst the present disclosure has been described with reference to the exemplary embodiments in the foregoing, the present disclosure is not limited to the above-described exemplary embodiments and it is contemplated that appropriate combinations of features of the exemplary embodiments as well as their replacement also fall within the present disclosure. Also, it is possible to add, to the exemplary embodiments, modifications such as reorganizing the combination and the order of the steps in the exemplary embodiments and other various design changes thereto based on the knowledge of those skilled in the art, and exemplary embodiments to which such modifications are made may also fall within the range of the present disclosure.

For example, in the above-described exemplary embodiments, whilst a case has been illustrated as an example where the holes 7 and 7A to 7C of the resin members 2 and 2A to 2C are a non-through hole, they are not limited to this and, the holes 7 and 7A to 7C may be a through hole that extends through the resin member 2 and 2A to 2C.

Also, in the above-described exemplary embodiments, whilst a case has been described as an example where the first member is made of a metal material, they are not limited to this and the first member may also be made of other materials with high strength other than the metal material.

Also, in the above-described exemplary embodiment, whilst a case has been described where the holes 6 and 6A to 6C and the corresponding holes 7 and 7A to 7C have the same figure (similarity), the holes 6 and 6A to 6C and the corresponding holes 7 and 7A to 7C may have shapes different from each other in a case where required joining strength and quality are guaranteed. For example, while the holes 6 and 6A to 6C may have a circular shape, the holes 6 and 6A to 6C may have an elliptical or rectangular shape.

Also, in the above-described exemplary embodiment, the hole forming pin 721 may have such a shape that a through hole is formed in the region of the resin member 2C corresponding to the hole 6 when the resin member 2C as the second member is formed. In other words, with regard to the hole forming pin 721, the tip of the hole forming pin 721 may be in contact with the core 701 when the metal member 1C is sandwiched in the die 700.

By virtue of this, it is made easier to make the hole 7c formed in the resin member 2C as a through hole.

Thus, it is understood that the foregoing description is that of the exemplary embodiments of the invention and that various changes and modifications may be made thereto without departing from the spirit and scope of the invention as defined in the appended claims.

What is claimed is:

1. A joining structure comprising:
a first member having a first surface and a second surface arranged on a back side of the first surface; and
a second member made of a resin material,
wherein the first member has a first hole that is formed so as to extend through the first member between the first surface and the second surface, the second member covers a region including the first hole on the first surface of the first member, the region including the first hole on the second surface of the first member, and an inner wall of the first member formed by the first hole, and is joined to the first member, and the second member has a second hole having a diameter smaller than that of the first hole, and the second hole is formed such that the second hole fits into the first hole.

2. The joining structure according to claim 1, wherein the resin material is a composite material containing fibers.

3. The joining structure according to claim 1, wherein the first member is made of a metal material.

4. The joining structure according to claim 1, wherein the second hole is coaxial with the first hole.

5. The joining structure according to claim 1, wherein the second hole is a through hole.

6. The joining structure according to claim 1, wherein the second hole is a non-through hole.

7. The joining structure according to claim 1, wherein a plurality of first holes are formed in the first member and a plurality of second holes are correspondingly formed at regions in the second member corresponding to the plurality of first holes.

8. A method of manufacturing a joining structure including a first member and a second member made of a resin material, the first and second members being joined to each other and the first member having a first hole extending through the first member, the method comprising:
placing the first member in a die for injection molding, the die having a protruding part a diameter of which being smaller than that of the first hole, the first member being placed in the die such that the protruding part fits into the first hole;
filling the die with a melted thermoplastic resin material in a state where the first member is sandwiched in the die; and
taking out, from the die, the first member formed in one piece with the second member with the melted thermoplastic resin material having cured.

9. The method according to claim 8, wherein the resin material is a composite material containing fibers.

10. The method according to claim 8, wherein the first member is made of a metal material.

11. The method according to claim 8, wherein the protruding part is formed such that the protruding part becomes coaxial with the first hole when the first member is placed in the die.

12. The method according to claim 8, wherein the protruding part is shaped such that a through hole is formed in a region of the second member corresponding to the first hole when the second member is formed.

13. The method according to claim 8, wherein the protruding part is shaped such that a non-through hole is formed in a region of the second member corresponding to the first hole when the second member is formed.

14. The method according to claim 8, wherein the die includes a core and a cavity, and the protruding part is formed in the cavity.
